(19) United States
(12) Patent Application Publication
(10) Pub. No.: US 2016/0131028 A1
(43) Pub. Date: May 12, 2016

(54) GAS TURBINE

(71) Applicant: MTU Aero Engines AG, Muenchen (DE)

(72) Inventors: Christoph Lauer, Muenchen (DE); Winfried Lauer, Muenchen (DE)

(21) Appl. No.: 14/935,005

(22) Filed: Nov. 6, 2015

(30) Foreign Application Priority Data
Nov. 10, 2014 (DE) DE102014222870.0

(51) Int. Cl. F02C 3/10; F02C 7/32; F02C 6/20

(52) U.S. Cl. CPC F02C 3/10; F02C 6/206; F02C 7/32; F05D 2220/323; F05D 2220/329; F05D 2240/40; F05D 2260/40

(57) ABSTRACT

A gas turbine, in particular an aircraft engine, including a core flow channel (K), in which a first compressor (20), a second compressor (40) adjacent downstream from the first compressor, a combustion chamber (60) adjacent downstream from the second compressor, a second turbine (50) adjacent downstream from the combustion chamber, which is coupled to the second compressor, and a first turbine (30) adjacent downstream from the second turbine, which is coupled to the first compressor via a first transmission (71), are situated; a quotient (r/R) of an inside diameter (r) of the core flow channel divided by an outside diameter (R) of the core flow channel at an upstream inflow of the first compressor being at most 0.65, in particular at most 0.5 is provided.

This claims the benefit of German Patent Application DE102014222870.0, filed Nov. 10, 2014 and hereby incorporated by reference herein.

The present invention relates to a gas turbine, in particular an aircraft engine, including a compressor and a turbine which is coupled via a transmission to the compressor.

### BACKGROUND

A gas turbine including a fan, an adjacent low-pressure compressor downstream thereof, an adjacent high-pressure compressor downstream thereof, an adjacent combustion chamber downstream thereof, an adjacent high-pressure turbine downstream thereof as well as an adjacent low-pressure turbine downstream thereof is known from EP 1 916 390 A2, in which the low-pressure turbine, is coupled to the fan with synchronized rotational speed and to the low-pressure compressor via a transmission.

A gas turbine including a low-pressure compressor and a fan, which are coupled via a transmission to a low-pressure turbine is known from US 2013/0259654 A1.

### SUMMARY OF THE INVENTION

It is an object of the present invention is to improve a gas turbine, in particular an aircraft engine.

The present invention provides a gas turbine, in particular an aircraft engine, includes a core flow channel which is in particular encased by a one-piece or multipart housing, in which a first compressor, a second compressor adjacent downstream from the first compressor, a combustion chamber adjacent downstream from the second compressor, a second turbine adjacent downstream from the combustion chamber, which is coupled to the second compressor and a first turbine adjacent downstream from the second turbine, which is coupled to the first compressor via a first transmission are situated.

In one embodiment, the first compressor is the most upstream compressor in the core flow channel, in particular a low-pressure compressor or a so-called booster. In another embodiment, the first compressor is a medium pressure compressor which is adjacent downstream from a low-pressure compressor in the core flow channel.

In one embodiment, the second compressor is a high-pressure compressor. In one embodiment, the second turbine is a high-pressure turbine. In one embodiment, it is coupled or connected to the second compressor by synchronized rotational speed or rigidly, preferably via a shared one-piece or multipart second shaft, in particular a hollow shaft, to which moving blades of the second turbine and of the second compressor may be detachably or permanently connected.

In one embodiment, the first turbine is a most downstream turbine in the core flow channel, in particular a low-pressure turbine. In another embodiment, the first turbine is a medium pressure turbine, adjacent to which is a low-pressure turbine downstream in the core flow channel.

In one embodiment, the first and/or second compressor is/are designed as axial-flow compressors having one or multiple moving grids spaced apart in the flow direction, and flowed-through axially, which are connected, in particular detachably, to a rotor of the gas turbine and have multiple moving blades distributed in the circumferential direction, where upstream and/or downstream from one or multiple of these moving grids an in particular stationary or adjustable moving grid fixed to the gas turbine housing, having multiple moving blades distributed in the circumferential direction, may be situated. Additionally or alternatively, in one embodiment, the first and/or second turbine is/are provided as axial turbine(s) including one or multiple moving grids spaced apart in the flow direction, and flowed-through axially, which are connected, in particular detachably, to a rotor of the gas turbine and have multiple moving blades distributed in the circumferential direction, where upstream and/or downstream from one or multiple of these moving grids, an in particular stationary or adjustable moving grid fixed to the gas turbine housing, having multiple moving blades distributed in the circumferential direction, may be situated

In one embodiment, a transition channel is situated between the first and the second compressors and/or between the first and the second turbines. In one embodiment, a transition channel is situated alternatively or additionally between an upstream inflow of the core flow channel and the first compressor, the axial length of which between the inflow of the core flow channel and an upstream inflow of the first compressor being preferably greater than an axial length between the upstream inflow and a downstream outflow of the first compressor. In particular, an axial length between the inflow of the core flow channel, in particular of a most upstream edge of a radial external lateral surface or external wall of the core flow channel, and a most upstream leading edge of the moving blades of the first compressor may be greater than an axial length between the most upstream leading edge and a most downstream trailing edge of the moving blades of the first compressor.

According to one aspect of the present invention, a quotient of an inside diameter of the core flow channel at an upstream inflow of the first compressor divided by an outside diameter of the core flow channel at the upstream inflow of the first compressor or a ratio between the inside diameter and outside diameter of the core flow channel at the upstream inflow of the first compressor is at most 0.65, in particular at most 0.5.

The outside diameter or inside diameter of the core flow channel at the upstream inflow of the first compressor in one embodiment is the outside diameter or inside diameter of the core flow channel at the axial height of a most upstream leading edge of the moving blades of the first compressor. In one embodiment, the outside diameter of the core flow channel at the upstream inflow of the first compressor, in particular at the axial height of the most upstream moving blade leading edge of the first compressor, is the diameter of a radial external wall of the housing of the gas turbine, which delimits and/or defines the core flow channel radially outside, in particular with a shroudless most upstream moving grid of the first compressor. Similarly, in one embodiment, the outside diameter of the core flow channel at the upstream inflow of the first compressor, in particular at axial height of the most upstream moving blade leading edge of the first compressor, may be the (inside) diameter of a radial external outer shroud of a most upstream moving grid of the first compressor, which delimits and/or defines the core flow channel radially outside. The inside diameter of the core flow channel at the upstream inflow of the first compressor, in particular at the axial height of the most upstream moving blade leading edge of the first compressor, in one embodiment is the (outside) diameter of a radial inner shroud or a hub of the most upstream moving grid of the first compressor, which delimits and/or defines the core flow channel radially inside.

Accordingly, this ratio is also referred to as a so-called hub-tip-ratio. Therefore, in one embodiment the hub-tip-ratio or the quotient of an inside diameter divided by an outside diameter of the core flow channel at the most upstream moving blade leading edge of the first compressor is at most 0.65, in particular at most 0.5.

Because of the upper limit of at most 0.65, in particular at most 0.5, according to the present invention, in one embodiment the outside diameter of the first compressor and therefore its weight may advantageously be reduced. In addition or alternatively, compared to known first compressors having a larger inside/outside diameter ratio, it is possible to reduce a number of blades at the compressor inflow of the first compressor. In addition or alternatively, as a result of an inside/outside diameter ratio according to the present invention, the aerodynamics and/or thermodynamics of the first compressor may be improved.

In one embodiment, the quotient of the inside diameter of the core flow channel divided by the outside diameter of the core flow channel at the upstream inflow of the first compressor, in particular of its most upstream moving blade leading edge, is at least 0.2, in particular at least 0.35.

Because of this lower limit of at least 0.2, in particular at least 0.35, in one embodiment the outside diameter of the first compressor and therefore its weight may advantageously be reduced. In addition or alternatively, compared to the first compressors having a larger inside/outside diameter ratio, it is possible to reduce a number of blades of the first compressor. In addition or alternatively, as a result of an inside/outside diameter ratio according to the present invention, the aerodynamics and/or thermodynamics of the first compressor maybe improved.

In one embodiment, the gas turbine has an airscrew including one or multiple rows of moving blades distributed in the circumferential direction.

The airscrew may in particular be a so-called fan, which is situated in a housing surrounding the core flow channel at a radial distance, the housing encasing a bypass flow channel surrounding the core flow channel. The fan may accordingly serve and/or be configured for the application of air to a bypass flow channel surrounding the core flow channel. In one embodiment, the fan is situated upstream from the first compressor, in particular upstream from an inflow of the core flow channel. In one embodiment, it feeds the core flow channel and the bypass flow channel, and/or is configured for this purpose. Therefore, the gas turbine may in particular be a so-called bypass turbine or a so-called turbofan.

The airscrew may similarly be in particular a jacket-free propeller, which in particular may be situated upstream from the first compressor, in particular from an inflow of the core flow channel. The gas turbine may therefore be in particular a so-called propeller turbine jet engine or a so-called turboprop.

The airscrew may similarly be in particular a helicopter rotor. The gas turbine may therefore be in particular a so-called helicopter engine.

In one embodiment, the airscrew is coupled to a turbine, in particular to the first turbine, the second turbine or a third turbine different from these, which is situated inside or outside of the core flow channel.

In the present case, coupling is understood to be primarily in particular a detachable, rotatably fixed connection between turbine and compressor or airscrew, in particular a form-locked, friction-locked or integrally rotatably fixed connection. In one embodiment, a turbine coupled to a compressor or to an airscrew is connected to these axially fixed or axially movable.

In one embodiment, the airscrew is coupled to the turbine, in particular to the first turbine, at a synchronized rotational speed, or rigidly.

In another embodiment, the airscrew is coupled to the turbine, in particular the first turbine, via a second transmission, the transmission ratio of a rotational speed of the airscrew relative to a rotational speed of the turbine coupled to it or between a rotational speed of the airscrew and a rotational speed of the turbine coupled to it in terms of absolute value is smaller than 1.0 or is between −1.0 and 1.0, in particular between −1.0 and 0. In other words, the second transmission reduces a rotational speed of the turbine in one embodiment into a slower rotational speed of the airscrew in comparison, or makes it slower. The second transmission may transmit the rotational speed equidirectionally (transmission ratio greater than 0) or counterdirectionally or counterrotatingly (transmission ratio less than 0).

As a result, the airscrew and the first compressor may work or be operated in different, respectively advantageous, rotational speed ranges.

In one embodiment, a transmission ratio of the first transmission of a rotational speed of the first compressor to a rotational speed of the first turbine coupled to it or between a rotational speed of the first compressor and a rotational speed of the first turbine coupled to it in terms of absolute value is greater than 1.0, i.e. smaller than −1.0 or greater than 1.0. In other words, the first transmission transmits a rotational speed of the first turbine into a higher rotational speed of the first compressor in comparison, or makes it faster. The first transmission may transmit the rotational speed equidirectionally (transmission ratio greater than 1) or counterdirectionally or counterrotatingly (transmission ratio less than −1).

As a result, the first turbine and the first compressor, in a refinement also the airscrew, may respectively work or be operated in advantageous rotational speed ranges different from one another. In particular, the transmission ratio of the first transmission may therefore be different in terms of absolute value from the transmission ratio of the second transmission.

In one embodiment, the transmission ratio of the first and/or second transmission is a fixed or load-independent, in particular unambiguously structurally predefined, transmission ratio. As a result, in one embodiment advantageously well-defined and/or reliable operating conditions may be presented. In this context, the fixed transmission ratio may be constant and/or selectable or switchable, the first and/or second transmission may correspondingly be a transmission having one or multiple gears or having fixed transmission ratios. In contrast to such a transmission, differential transmissions have no fixed but load-dependent transmission ratios.

In one embodiment, in particular in an embodiment in which the airscrew is coupled via the second transmission to the turbine, in particular the first turbine, the transmission ratio of the first transmission of the rotational speed of the first compressor to the rotational speed of the first turbine coupled to it or between the rotational speed of the first compressor and the rotational speed of the first turbine coupled to it is at most 1.45 or is in a range between −1.45 and 1.45, in particular between −1.45 and −1.0 or between 1.0 and 1.45. The transmission ratio of the first transmission is preferably at most 1.40 or is in a range between −1.40 and 1.40, in particular between −1.40 and −1.0 or between 1.0 and 1.40.

In one embodiment, in particular in an embodiment in which the airscrew is coupled at a synchronized rotational speed to the turbine, in particular to the first turbine, the transmission ratio of the first transmission of the rotational speed of the first compressor to the rotational speed of the first turbine coupled to it or between the rotational speed of the first compressor and the rotational speed of the first turbine coupled to it is at most 2.9 or is in a range between −2.9 and 2.9, in particular between −2.9 and −1.0 or between 1.0 and 2.9. Preferably, the transmission ratio of the first transmission is at most 2.8 or is in a range between −2.8 and 2.8, in particular between −2.8 and −1.0 or between 1.0 and 2.8.

As a result, in a first embodiment the first turbine and the first compressor may work or be operated in particularly advantageous rotational speed ranges.

In one embodiment, the first transmission and/or the second transmission have one or multiple planetary gear stages and/or one or multiple spur gear stages. In this context, a shaft connected to the moving blades of the first compressor or to the airscrew may have a toothing of the transmission and a shaft connected to the first turbine may have a further toothing of the transmission. In one embodiment, the first and the second transmission are situated in a shared housing. This may advantageously accomplish a compact structural design and/or the first and second transmissions may have a shared lubricant supply and/or cooling.

The first and/or a second transmission, in particular its/their housing, in one embodiment are situated upstream from the inflow of the first compressor, in particular upstream from a most upstream moving blade leading edge of the first compressor, and/or downstream from the airscrew, in particular downstream from a most downstream moving blade trailing edge. This may advantageously optimize installation space and/or flow guidance.

In one embodiment, the quotient of the outside diameter of a most upstream moving blade leading edge of the first compressor divided by a minimal inside diameter of a most downstream trailing edge of the moving blades of the airscrew is smaller than 0.95, in particular equal to 0.9 at most. As a result, a compact structural design, in particular a steeply downward sloping transition channel, may be advantageously presented.

Further advantageous refinements of the present invention result from the following description of preferred embodiments.

### BRIEF DESCRIPTION OF THE DRAWINGS

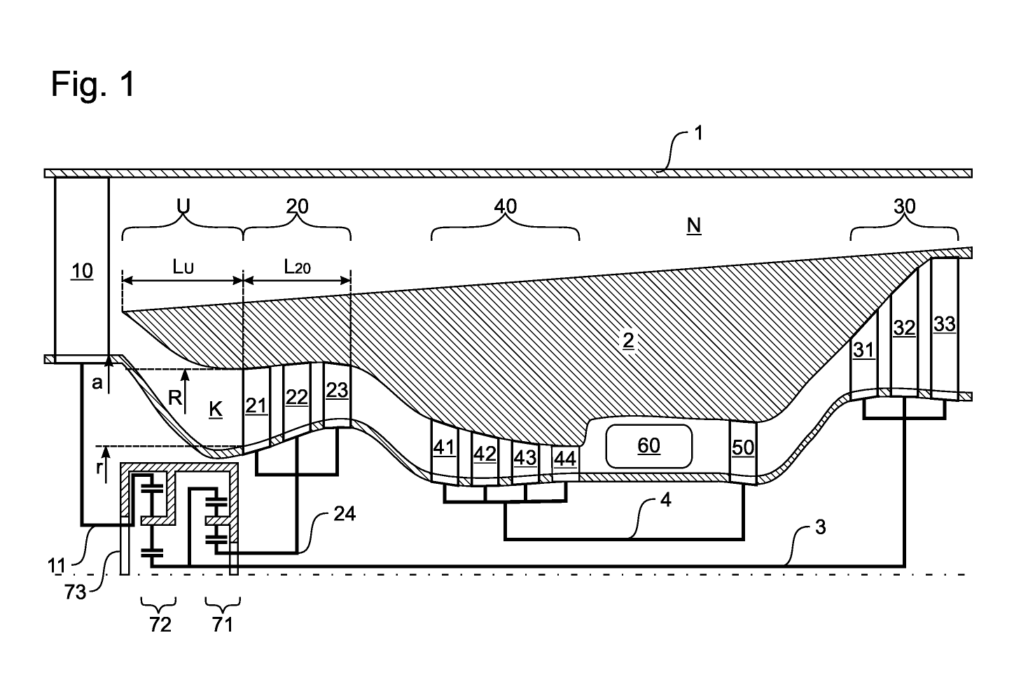

The sole FIG. 1 partially schematically shows the upper half of a gas turbine according to one embodiment of the present invention, as a section.

### DETAILED DESCRIPTION

FIG. 1 shows the upper half of a gas turbine according to one embodiment of the present invention, as a section. The lower half is analogous to this and is not shown for reasons of clarity.

The gas turbine has an outer housing 1 and an inner housing 2 which define a bypass flow channel N radially between them.

A core flow channel K is situated in inner housing 2, in which a first compressor 20, a downstream adjacent second compressor 40 (on the right in FIG. 1), a downstream adjacent combustion chamber 60, a downstream adjacent second turbine 50, which is coupled to the second compressor by a hollow shaft 4, and a downstream adjacent first turbine 30, which is coupled to the first compressor via a first transmission 71, are situated.

The first and second compressors are designed as axial-flow compressors including multiple moving grids, which have multiple moving blades 21-23 and 41-44 distributed in the circumferential direction, where upstream and/or downstream from one or multiple of these moving grids, one moving grid including multiple guide blades distributed in the circumferential direction may be situated (not shown for reasons of clarity). First turbine 30 is designed as an axial flow turbine including one moving grid, the second turbine is designed as axial flow turbine including multiple moving grids, which have multiple moving blades 31-33 distributed in the circumferential direction, where upstream and/or downstream from one or multiple of these moving grids one moving grid including multiple guide blades distributed in the circumferential direction may be situated (not shown for reasons of clarity).

A transition channel U is situated between an upstream inflow of the core flow channel and the first compressor, the axial length L_{U} of the transition channel between the inflow of the core flow channel (on the left in FIG. 1) and the upstream inflow of the first compressor and its most upstream leading edge of the moving blades 21 being greater than an axial length L₂₀ between this upstream inflow and a downstream outflow and a most downstream trailing edge of the moving blades 23 of the first compressor. In a modification (not shown), the ratio of the axial lengths L_{U}, L₂₀ may also be selected differently.

A quotient r/R (“hub-tip-ratio”) of an inside diameter r of the core flow channel at the upstream inflow of the first compressor, in particular the outside diameter of a radial inner shroud of the most upstream moving blades 21, at axial height of the most upstream moving blade leading edge of the moving blades 21, divided by an outside diameter R of the core flow channel on the most upstream inflow of the first compressor, in particular the diameter of a radial external wall of [inner] housing 2, which delimits the core flow channel radially outside, or the inside diameter of a radial external outer shroud of the most upstream moving blades 21, which delimits the core flow channel radially outside, at this axial position amounts to approximately 0.5 in the exemplary embodiment.

The gas turbine has a fan with a row of moving blades 10 [sic; 21] distributed in the circumferential direction, which is situated in outer housing 1 surrounding the core flow channel K with radial spacing, the outer housing encasing the bypass flow channel N surrounding the core flow channel upstream from the inflow of the core flow channel K.

Fan 10 is coupled to first turbine 30 via a second transmission 72, whose fixed transmission ratio of a rotational speed of the fan to a rotational speed of [first] turbine 30 is approximately ⅓. The fixed transmission ratio of first transmission 71 of a first rotational speed of first compressor 20 to the rotational speed of first turbine 30 is approximately 1.4.

First and second transmissions 71, 72 in the exemplary embodiment include, respectively, a planetary gear stage, a shaft 24 connected to moving blades 21-23 of first compressor 20 having a sun wheel toothing of first transmission 71, a shaft 11 connected to the moving blades of fan 10, having an internal gear toothing of second transmission 72, and a shaft 3 connected to first turbine 30, having an internal gear toothing of first transmission 71 and a sun wheel toothing of second transmission 72.

The first and second transmissions are situated in a shared transmission housing 73 upstream from a most upstream moving blade leading edge of first compressor 20 and downstream from a trailing edge of fan 10.

A quotient R/a of outside diameter R divided by a minimal inside diameter a of a most downstream trailing edge of the moving blades of fan 10 is approximately 0.9. In a modification (not shown), the quotient R/a may also be selected differently.

Although exemplary embodiments were discussed in the preceding description, it must be pointed out that multiple modifications are possible. Moreover it must be pointed out that the exemplary embodiments merely involve examples, which are not intended to limit the scope of protection, the applications and the design in any way. The preceding description rather provides those skilled in the art with a guide for the implementation of at least one exemplary embodiment, whereby various changes, in particular with regard to the function and configuration of the described components, may be made without departing from the scope of protection as revealed by the claims and these equivalent combinations of features.

### LIST OF REFERENCE NUMERALS

1 outer housing
2 inner housing
3, 4 shaft
10 fan
11 shaft
20 first compressor
21-23 blades
24 shaft
30 first turbine
31-33 blades
40 second compressor
41-44 blades
50 second turbine
60 combustion chamber
71 first transmission
72 second transmission
73 transmission housing
a fan inside diameter
K core flow channel
N bypass flow channel
R outside diameter at inflow of first compressor
r inside diameter at inflow of first compressor
U transition channel
L axial length

What is claimed is:

1. A gas turbine comprising:
a core flow channel;
a first compressor, a second compressor adjacent downstream from the first compressor, a combustion chamber adjacent downstream from the second compressor, a second turbine adjacent downstream from the combustion chamber and coupled to the second compressor, and a first turbine adjacent downstream from the second turbine and coupled to the first compressor via a first transmission, situated in the core flow channel;
a quotient (r/R) of an inside diameter (r) of the core flow channel divided by an outside diameter (R) of the core flow channel on an upstream inflow of the first compressor being at most 0.65.

2. The gas turbine as recited in claim 1 further comprising an airscrew having multiple moving blades situated in a housing surrounding the core flow channel at a radial distance, defining a jacket-free propeller or helicopter rotor and coupled to the first turbine.

3. The gas turbine as recited in claim 2 wherein the airscrew is a fan.

4. The gas turbine as recited in claim 2 wherein the airscrew is coupled to the first turbine via a second transmission.

5. The gas turbine as recited in claim 4 wherein the first and second transmissions are situated in a shared transmission housing.

6. The gas turbine as recited in claim 4 wherein a fixed transmission ratio of the second transmission of a rotational speed of the airscrew to a rotational speed of the first turbine is less than 1.0 in terms of absolute value.

7. The gas turbine as recited in claim 2 wherein the airscrew is coupled to the first turbine at a synchronized rotational speed.

8. The gas turbine as recited in claim 2 wherein a quotient (R/a) of the outside diameter (R) of a most upstream moving blade leading edge of the first compressor divided by a minimal inside diameter (a) of a most downstream trailing edge of the moving blades of the airscrew is less than 0.95.

9. The gas turbine as recited in claim 1 wherein that a transmission ratio of the first transmission of a rotational speed of the first compressor to a rotational speed of the first turbine, is greater than 1.0 in terms of absolute value or at most 2.9.

10. The gas turbine as recited in claim 9 wherein that the transmission ratio of the first transmission of the rotational speed of the first compressor to the rotational speed of the first turbine is at most 1.45.

11. The gas turbine as recited in claim 1 wherein the quotient (r/R) of the inside diameter of the core flow channel divided by the outside diameter of the core flow channel is at least 0.2 at the upstream inflow of the first compressor.

12. The gas turbine as recited in claim 1 wherein the first compressor is an axial compressor including a plurality of moving blades spaced apart in the flow direction.

13. The gas turbine as recited in claim 1 wherein the first transmission includes at least one planetary gear stage or spur gear stage.

14. The gas turbine as recited in claim 1 wherein a transition channel is situated between an upstream inflow of the core flow channel and the first compressor, an axial length of the transition channel being greater than an axial length between the upstream inflow and a downstream outflow of the first compressor.

15. The gas turbine as recited in claim 1 wherein the first transmission is situated upstream from the inflow of the first compressor.

16. The gas turbine as recited in claim 1 wherein the quotient (r/R) is at most 0.5.

17. An aircraft engine comprising the gas turbine as recited in claim 1.
